(19) United States
(12) Patent Application Publication
(10) Pub. No.: US 2007/0195028 A1
(43) Pub. Date: Aug. 23, 2007

(54) Display device

(76) Inventors: Yukari Katayama, Chigasaki (JP); Yasuyuki Kudo, Fujisawa (JP); Toshimitsu Matsudo, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/605,997

(22) Filed: Nov. 30, 2006

(30) Foreign Application Priority Data
Feb. 8, 2006 (JP) 2006-030416

(51) Int. Cl. G09G 3/36

(52) U.S. Cl. 345/87

(57) ABSTRACT

A display device in which one frame period is divided to a plurality of field periods, it is made possible to set gray scale voltage groups of a plurality of kinds depending on the field period, and a gray scale voltage is equipped with a function of generating and outputting gray scale voltage groups of different kinds according to the field period.

### INCORPORATION BY REFERENCE

The present application claims priority from Japanese application JP2006-030416 filed on Feb. 8, 2006, the content of which is hereby incorporated by reference into this application.

### BACKGROUND OF THE INVENTION

The present invention relates to a hold-type display device such as a liquid crystal display device, an organic EL (Electro Luminescence) display or a LCOS (Liquid Crystal On Silicon) display. In particular, the present invention relates to a display device suitable for display of a moving picture.

If displays are classified especially from the viewpoint of moving picture display, the displays are divided broadly into impulse-response type (hereafter referred to as impulse-type) displays and hold-response type (hereafter referred to as hold-type) displays. In the impulse-type displays, luminance response falls from immediately after scanning like after-glow characteristics in cathode-ray tubes. In the hold-type displays, luminance based on display data continues to be held until the next scanning as in liquid crystal displays.

As a feature of the hold-type display, a favorable display quality without flicker can be obtained in the case of a still picture. In the case of a moving picture, however, the circumference of a moving object looks blurred, that is, the so-called moving picture blurring occurs, resulting in a problem of a remarkably lowered display quality. The moving picture blurring is caused by the so-called retina after-image: when moving the vision as the object moves, the observer interpolates display images before and after the movement with respect to a display image held in luminance. No matter how much the response speed of the display may be improved, therefore, the moving picture blurring is not completely eliminated. For solving this problem, it is effective to make the hold-type display similar to the impulse-type display by updating the display image at a high frequency or inserting a black screen to cancel the retina after-image once.

On the other hand, a representative display required to provide moving pictures is the TV set. Standardized signals are used for the TV set. As for its scanning frequency, interlaced scanning at 60 Hz is prescribed in, for example, the NTSC signal, and progressive scanning at 50 Hz is prescribed in the PAL signal. If the frame frequency of the display image generated on the basis of this frequency is set to 60 Hz or 50 Hz, then the frequency is not high and consequently moving picture blurring is caused.

As for the above-described technique of updating the image at a high frequency used as means for improving the moving picture blurring, a technique of raising the scanning frequency, generating display data for interpolation frames on the basis of display data between frames, and raising the image updating speed (hereafter abbreviated to interpolation frame generation method) is described in U.S. Patent Publication No. 2004/101058 (JP-A-2005-6275).

As for the technique of inserting a black frame (a black image), a technique of inserting black display data between display data (hereafter abbreviated to black display data insertion system) is described in U.S. Pat. No. 7,027,018 (JP-A-2003-280599). In the same way, a technique of repeating the lighting and extinguishing of backlight (hereafter abbreviated to blink backlight system) is described in U.S. Patent Publication No. 2002/067332 (JP-A-2003-50569).

The black display data insertion system is excellent as a system for remedying the moving picture blurring. However, the black display data insertion system has a problem that the luminance in the whole screen falls because of insertion of the black display data. In order to remedy the problem, black display data is not inserted in high luminance images and black display data is inserted only in low luminance images, according to a method described in JP-A-2003-315765. In the same way, according to a system described in U.S. Patent Publication No. 2004/155847 (JP-A-2004-240317), one frame period is divided to two field periods and the number of pixel data is increased to twice. The pixel data increased in number to twice are written into a first field period included in the two field periods. Only if the pixel data increased in number to twice have exceeded a displayable range, remained pixel data are written into a second field.

### SUMMARY OF THE INVENTION

Although the moving picture blurring can be remedied by applying the above-described technique, it is known that problems described hereafter are posed by applying the technique.

As regards the interpolation frame generation method, display data which are not originally present are generated. If it is attempted to generate more accurate data, therefore, the circuit scale becomes large. On the contrary, if the circuit scale is held down, interpolation generation mistakes occur, resulting in a fear of a remarkably lowered display quality.

On the other hand, in the technique of inserting black frames, the interpolation generation mistakes are not caused in principle and it is advantageous as compared with the interpolation frame generation method with respect to the circuit scale as well. In both the black display data insertion system and the blink backlight system, however, the display luminance in every gray scale level falls by the amount corresponding to the black frame. If the backlight luminance is raised for the black display data insertion system in order to compensate the luminance fall, the power consumption increases by that amount and much labor is needed to take a measure against the generated heat. In addition, since the absolute value of light leak in the black display increases, contrast falling is caused. On the other hand, in the blink backlight system, a large current is needed to proceed from the extinguishing state to the lighting state and coloring is caused because the visible light response speed differs every wavelength due to differences in phosphor material.

As regards the system in which black is inserted only in images having low luminance, the contrast extremely falls in low luminance images or there is unnaturalness that the luminance suddenly falls on a luminance boundary across which black is inserted and black is not inserted.

In the system in which one frame is divided to two field periods and pixel data increased to twice are written, there is a problem that visual luminance corresponding to given pixel data cannot always be obtained depending upon the liquid crystal characteristics. If it is attempted to take the liquid crystal characteristics into consideration in the system, it is eventually necessary to generate both data for high luminance frames and low luminance frames and this results in a problem that the scale of a data generation circuit becomes large. In recent years, the demand for moving picture handling is increasing even in the field of small-sized liquid crystal display devices such as portable game machines. The system has a problem that the circuit scale required for the data generation is too large to be mounted on a small-sized liquid crystal driver.

An object of the present invention is to provide a display device in which moving picture blurring is reduced with a small circuit scale while suppressing luminance falling, contrast falling and an increase in power required for light emission.

In accordance with the present invention, a gray scale level requested from the external system is displayed spuriously by making it possible to set gray scale voltages of a plurality of kinds in a voltage generation circuit, dividing one frame to a plurality of fields, and changing over the gray scale voltages of the kinds to use them, every field. Among the gray scale voltages of the kinds, at least one kind is set to a gray scale voltage which gives a high luminance as compared with a gray scale voltage used when the changeover is not conducted, and at least another kind is set to a gray scale voltage which gives a low luminance as compared with the gray scale voltage used when the changeover is not conducted.

Furthermore, in accordance with the present invention, a gray scale level requested from the external system is displayed spuriously by making it possible to set different gray scale voltages every field in a voltage generation circuit, and changing over the different gray scale voltages to use them, every frame. Among the different gray scale voltages, one kind is set to a gray scale voltage which gives a high luminance as compared with a gray scale voltage used when the changeover is not conducted, and another kind is set to a gray scale voltage which gives a low luminance as compared with the gray scale voltage used when the changeover is not conducted. A difference between luminance given by the gray scale voltage giving the high luminance and the luminance given by the display device when the changeover is not conducted is made equal to a difference between luminance given by the gray scale voltage giving the low luminance and the luminance given by the display device when the changeover is not conducted.

According to the present invention, the voltage generation circuit generates different gray scale voltages depending on the field periods in one frame period, and the gray scale voltages are changed over and used depending on the field period. As a result, high luminance display and low luminance display can be changed over and displayed in one frame period. Therefore, the moving picture blurring can be reduced while suppressing the luminance falling and the contrast falling.

According to the present invention, the display device reduced in moving picture blurring can be implemented by only changing over and using the voltage generation circuit. Therefore, the circuit scale can be made small.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing a configuration of a liquid crystal display device in first and second embodiments;

FIG. 2 is a diagram showing a basic concept of the present invention;

FIGS. 3A to 3C are diagrams showing relations between gray scale data and a gray scale voltage and relations between gray scale data and a gray scale luminance in the first embodiment;

FIG. 4 is a diagram showing a liquid crystal drive waveforms in the first embodiment;

FIG. 5 is a diagram showing an example of a data storage method for a display memory;

FIG. 6 is a diagram showing a liquid crystal drive waveforms in a second embodiment;

FIGS. 7A to 7C are diagrams showing relations between gray scale data and a gray scale voltage and relations between gray scale data and a gray scale luminance in the second embodiment;

FIG. 8 is a diagram showing an operation concept in the second embodiment;

FIG. 9 is a diagram a method for setting a gray scale voltage when there is a large difference between characteristics of a rising waveform and those of a falling waveform in liquid crystal voltage luminance characteristics;

FIG. 10 is a diagram showing a concept of the present invention;

FIG. 11 is a diagram a method for setting a gray scale voltage when there is a large difference between characteristics of a rising waveform and those of a falling waveform in liquid crystal voltage luminance characteristics; and

FIG. 12 is a diagram showing a configuration of a timing generation circuit in a liquid crystal display device in the first and second embodiments.

### DESCRIPTION OF THE EMBODIMENTS

Hereafter, in the present specification, it is supposed that a period corresponding to one screen input from an external system is defined as one frame period and a period over which all scanning lines are selected for a display panel is defined as one field period. In a typical display device, therefore, one frame period becomes equal to one field period.

Luminance obtained in the display device by repeating scanning in a state in which display state is constant is referred to as static luminance, average luminance over one field period is referred to as dynamic luminance, and luminance recognized visually by an observer is referred to as visual luminance. If the display data does not change in the typical hold-type display device, therefore, the static luminance, the dynamic luminance and the visual luminance become substantially equal to each other.

In accordance with the present invention, a plurality of field periods (for example, two field periods or three field periods) are assigned to one frame period input from the external system, and display data input from the external system is converted to voltage values which are different from field to field. As a result in this case, the dynamic luminance assumes different values every field. A voltage value given every field is given so as to make the visual luminance nearly coincide with an average value of the dynamic luminance over a plurality of field periods. It is desirable to divide one frame period into equal field periods. However, one frame period may not be divided into equal field periods.

As for the conversion to the voltage values, the conversion is conducted so as to make dynamic luminance in one field higher than or equal to dynamic luminance in the other field at all gray scale levels. When such conversion is conducted, hereafter a field having higher luminance as compared with the other field is referred to as bright field and a field having low luminance is referred to as dark field. In the low luminance region, it is desirable to set the luminance in the dark field to a lowest luminance and set the luminance in the bright field to an intermediate luminance. In other words, the visual luminance changes depending upon whether the luminance in the bright field is high or low. On the other hand, in the high luminance region, it is desirable to set the luminance in the bright field to a highest luminance and set the luminance in the dark field to the intermediate luminance. In other words, the visual luminance changes depending upon whether the luminance in the dark field is high or low.

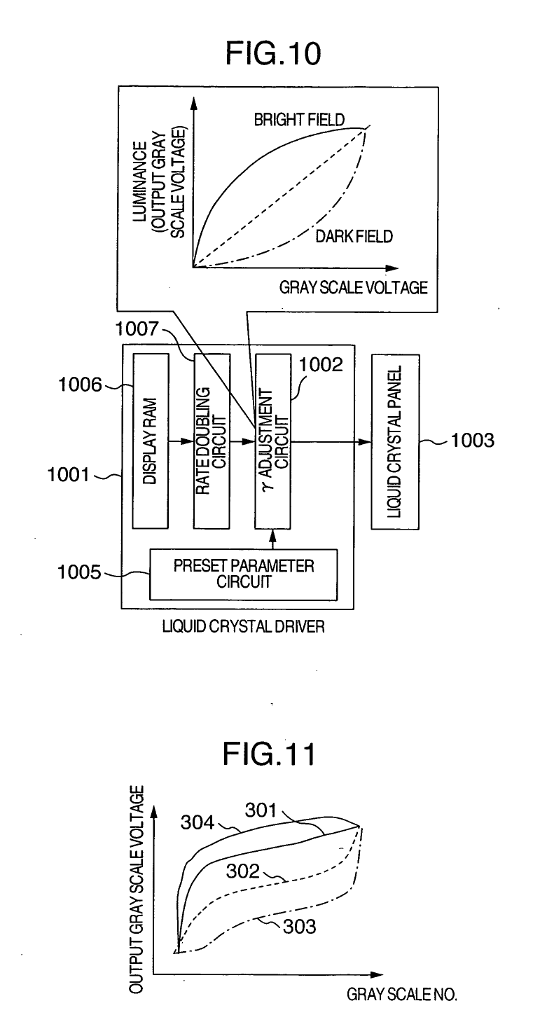

FIG. 10 is a diagram showing the concept of the present invention. Display data corresponding to one frame input from the external system are stored in a display RAM 1006 included in a liquid crystal driver 1001. The data corresponding to one frame stored in the display RAM 1006 are read out by a rate doubling circuit 1007 at a doubled rate twice. A preset parameter circuit 1005 can preserve γ curve setting preset parameters of two kinds for the bright field and the dark field. A γ adjustment circuit 1002 converts the data corresponding to once included in data read out twice, to a gray scale voltage by using the bright field parameters, and outputs the gray scale voltage to a liquid crystal panel 1003. The γ adjustment circuit 1002 converts the data corresponding to the other time included in the data read out twice, to a gray scale voltage by using the dark field parameters, and outputs the gray scale voltage to the liquid crystal panel 1003. Owing to such operation, moving picture blurring can be remedied with a small circuit scale.

A gray scale voltage given in a first field period is set to become higher than a gray scale voltage that gives a dynamic luminance to be displayed by display data in all display data. A gray scale voltage given in a second field period is set to become lower than a gray scale voltage that gives a dynamic luminance to be displayed by display data in all display data. On the contrary, it is also possible to set a gray scale voltage given in a first field period so as to make it lower than a gray scale voltage that gives a dynamic luminance to be displayed by display data in all display data, and set a gray scale voltage given in a second field period so as to make it higher than a gray scale voltage that gives a dynamic luminance to be displayed by display data in all display data.

It is desirable to make a difference between a dynamic luminance obtained by the gray scale voltage given in the first field period and the luminance to be displayed according to the display data equal to a difference between a dynamic luminance obtained by the gray scale voltage given in the second field period and the luminance to be displayed according to the display data. If time required for luminance to change from luminance corresponding to black display and reach luminance corresponding to white display when changeover from the black display to the white display is conducted is longer than time required for luminance to change from luminance corresponding to white display and reach luminance corresponding to black display when changeover from the white display to the black display and longer than the field period time, then a difference between a dynamic luminance obtained from a gray scale voltage in a field period that gives a low luminance and a luminance to be displayed according to display data is larger than a difference between a dynamic luminance obtained from a gray scale voltage in a field period that gives a high luminance and a luminance to be displayed according to display data. On the contrary, if time required for luminance to change from luminance corresponding to white display and reach luminance corresponding to black display when changeover from the white display to the black display is conducted is longer than time required for luminance to change from luminance corresponding to black display and reach luminance corresponding to white display when changeover from the black display to the white display and longer than each field period, then a difference between a dynamic luminance obtained from a gray scale voltage in a field period that gives a low luminance and a luminance to be displayed according to display data may be larger than a difference between a dynamic luminance obtained from a gray scale voltage in a field period that gives a high luminance and a luminance to be displayed according to display data.

Hereafter, a first embodiment which is one of best embodiments of the present invention will be described.

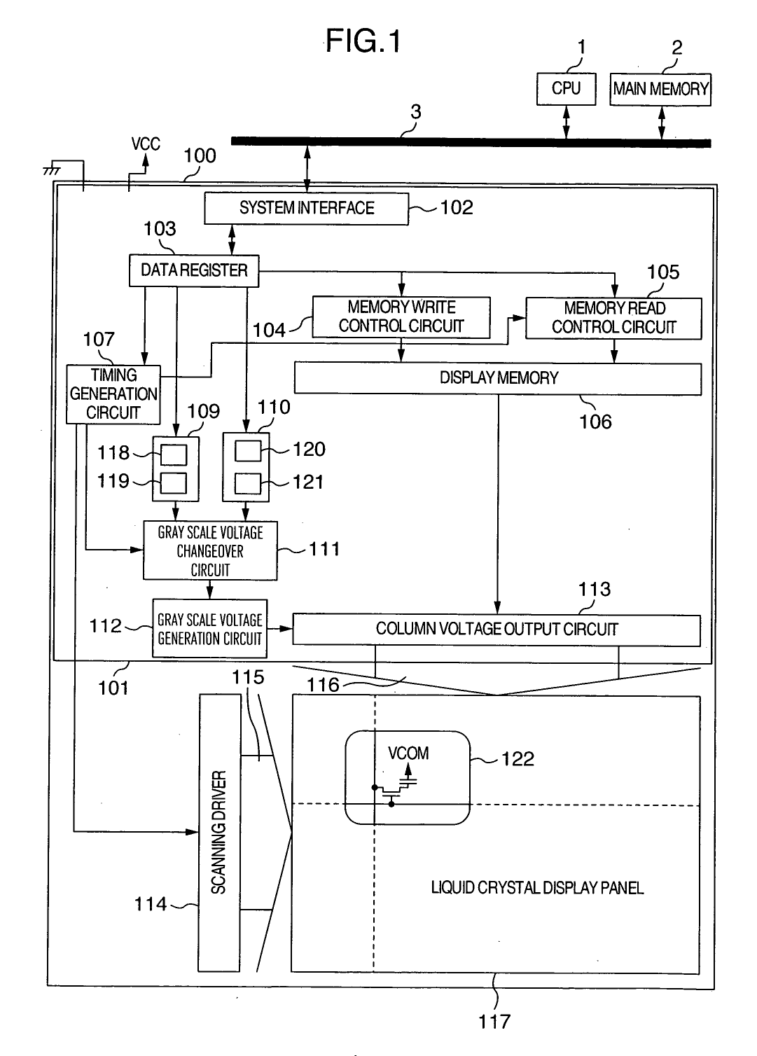

FIG. 1 is a block diagram of a display device in the first embodiment. In FIG. 1, reference numeral 100 denotes a display device, 101 a column drive circuit (data driver) for outputting a gray scale voltage according to display data which indicates a gray scale level, 117 a liquid crystal display panel, and 114 a scanning driver for sequentially scanning pixel lines on the liquid crystal display panel 117, for example, every horizontal period. In the column drive circuit 101, reference numeral 102 denotes a system interface for receiving display data, control signals (such as synchronizing signals) and control data (such as the γ value) from external systems (CPU 1 and a main memory 2) via a system bus 3, 103 a data register for setting control data, 107 a timing generation circuit for generating timing signals (such as the horizontal synchronizing signal and the vertical synchronizing signal), 104 a memory write control circuit for controlling write operation to a display memory 106, 105 a memory read control circuit for controlling read operation from the display memory 106, 106 a display memory capable of storing display data corresponding to at least one frame (one screen), 109 a first gray scale voltage conversion value storage memory for storing a first gray scale voltage conversion value, 110 a second gray scale voltage conversion value storage memory for storing a second gray scale voltage conversion value, 111 a gray scale voltage changeover circuit for changing over between the first gray scale voltage conversion value and the second gray scale voltage conversion value, 112 a gray scale voltage generation circuit for generating a plurality of voltages according to a plurality of display data, and 113 a column voltage output circuit (digital/analog conversion circuit) for selecting a gray scale voltage according to display data from among gray scale voltages having a plurality of levels and outputting the gray scale voltage.

The liquid crystal display panel 117 is driven by a column drive line 116 which is in turn driven by the column voltage output circuit 113, and a row drive line 115 which is in turn driven by a scanning driver 114. In the liquid crystal display panel 117, reference numeral 122 denotes a pixel part. The pixel part 122 is, for example, a low temperature polysilicon TFT element, and formed on a glass substrate. A display element driven by the pixel part 122 is, for example, TN type liquid crystal. By applying a predetermined voltage level, the display element conducts multi-color display. It is supposed that display data input to the display device is digital data having 8 bits for each of R (red), G (green) and B (blue). However, the number of bits for each color is not restricted to this. In some cases, the column drive line is called signal line and the row drive line is called scanning line. In the present embodiment, however, the terms “column drive” and “row drive” will be used. By the way, the system interface 102 may be disposed within the column drive circuit 101, or may be disposed outside the column drive circuit 101. As for a polarity in the pixel unit 122, it is supposed that the polarity is positive when the gray scale voltage is higher than a voltage at a counter electrode and the polarity is negative when the gray scale voltage is lower than the voltage at the counter electrode.

Operation of the display device in the first embodiment will now be described.

Operation of the column drive circuit 101 will now be described. Control data for controlling the operation of the display device are supplied from the CPU 1 to the column drive circuit 101 via the system bus 3. The control data include data concerning a display position of the display data, the number of drive lines, and the frame frequency.

The system interface 102 writes the control data to an address specified by the CPU 1, in the data register 103. Various control data stored in the data register 103 are output to blocks. For example, the display data is output to the display memory 106, the display position data is output to the memory write control circuit 104, and the data concerning the number of drive lines and the frame frequency are output to the timing generation circuit 107. If the display memory 106 has a capacity corresponding to only one frame, timing of writing to the display memory is in synchronism with the frame frequency. If the display memory 106 has a capacity corresponding to at least two frames, odd-numbered frames and even-numbered frames are written to different addresses.

The memory write control circuit 104 decodes the display position data, and selects a bit line and a word line in the display memory 106 corresponding to the display position. At the same time, the memory write control circuit 104 outputs display data from the data register 103 to the display memory 106 and completes write operation.

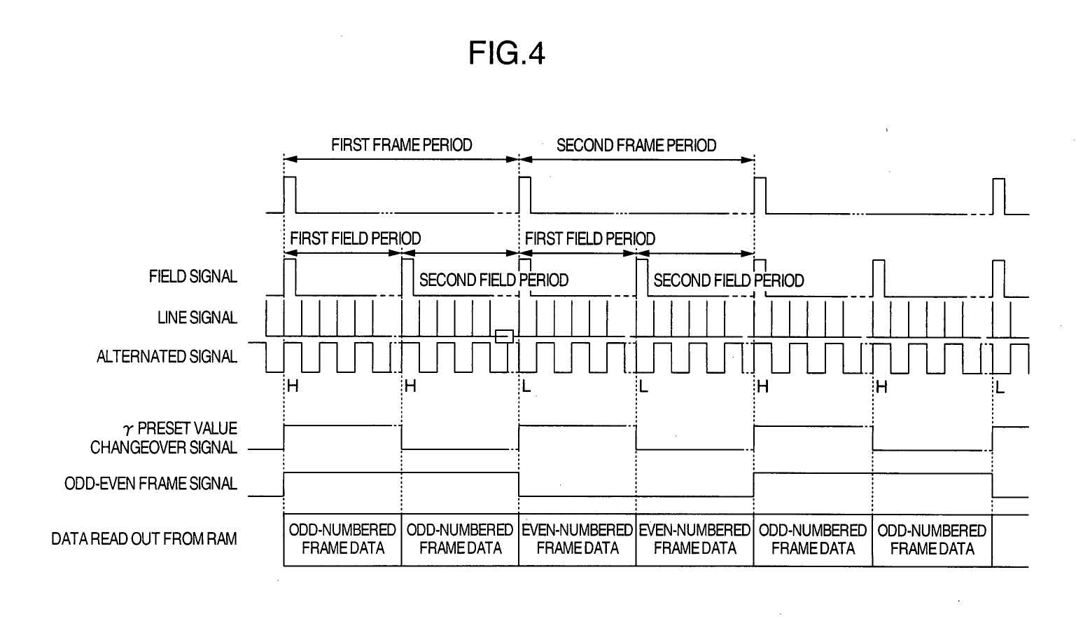

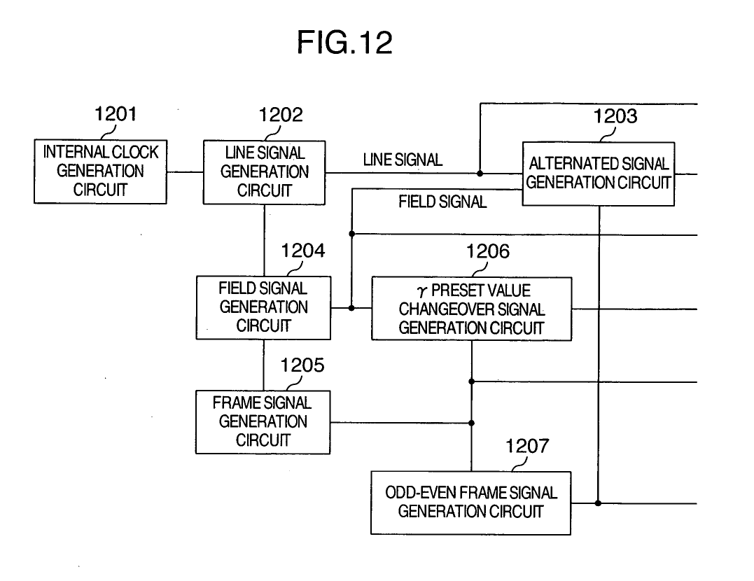

FIG. 12 is a detailed block diagram of the timing generation circuit 107. The timing generation circuit 107 is driven by an internal clock having a frequency equal to at least (frame frequency×2× the number of lines in the panel) which is generated by an internal clock generation circuit 1201 and which is not illustrated. The timing generation circuit 107 generates a timing signal group shown in FIG. 4 by itself on the basis of drive data supplied from the data register 103, and outputs the timing signals to the memory read control circuit 105 and the column voltage output circuit 113.

In the present embodiment, the internal clock has a waveform of a line signal shown in FIG. 4 and has a frequency of (frame frequency×2× (the number of lines in the panel +α)). Here, a is an appropriate number which gives time between the last line writing and the first line writing (for example, retrace period). For example, a is approximately 16. A line signal generation circuit 1202 generates the line signal shown in FIG. 4 from the internal clock. In the present embodiment, the internal clock becomes the line signal as it is. A field signal generation circuit 1204 includes a counter having a count which increments according to the line signal. If the count has reached the number of lines +α, then the counter outputs a field signal and the count returns to “0.” As a result, a field signal is generated every (the number of lines +α) lines. A frame signal generation circuit 1205 includes a counter having a count which increments according to the field signal. If the count has reached 2, then the counter outputs a frame signal and the count returns to “0.” As a result, a frame signal is generated every two fields as shown in FIG. 4. An odd-even frame signal generation circuit 1207 is a 1-bit counter having a count which increments according to the frame signal. The output of the odd-even frame signal generation circuit 1207 changes from “High” to “Low,” then to “High,” and then to “Low” each time a frame signal is input. As a result, an odd-even frame signal shown in FIG. 4 is generated. A γ preset value changeover signal generation circuit 1206 includes a 1-bit counter which is set by a frame signal and which is incremented in count by a field signal. The γ preset value changeover signal generation circuit 1206 outputs a γ preset value changeover signal which is “High” over a first field in each frame and “Low” over a second field. An alternated signal generation circuit 1203 includes a 1-bit counter which is reset by a field signal and which is incremented in count by a line signal. An alternated signal is generated so as to alternate between “High” and “Low” in level every line. The alternated signal is generated as an exclusive-OR output of the output value of the counter and the odd-even frame signal. As shown in FIG. 4, therefore, the alternated signal is generated so as to have the same polarity on the same line in the same frame and have an opposite polarity in the next frame. For example, in the first frame period, the alternated signal is generated so as to be “High” on the first line and “Low” on the second line in both the first period and the second field period. In the second frame period, the alternated signal is generated so as to be “Low” on the first line and “High” on the second line in both the first period and the second field period. In the third frame period, the alternated signal is generated so as to be “High” on the first line and “Low” on the second line in both the first period and the second field period. The γ preset value changeover signal is generated so as to alternate in polarity between “High” and “Low” every field.

The memory read control circuit 105 decodes a signal output by the timing generation circuit 107 and selects a pertinent word line in the display memory 106. In this operation, selection is conducted row by row beginning with, for example, a word line with which display data of a head row on the screen is stored in association. After a final row, return to the head row is conducted and the operation is repeated. Concurrently with the word line selection operation, display data corresponding to one row is output from a data line of the display memory 106 in a lump. Here, word line changeover timing is synchronized to the line signal supplied from the timing generation circuit 107. Timing for selecting a word line of the head row is synchronized to a field signal supplied from the timing generation circuit 107. If the display memory has a capacity of two or more frames, a readout head address is changed in synchronism with a frame signal.

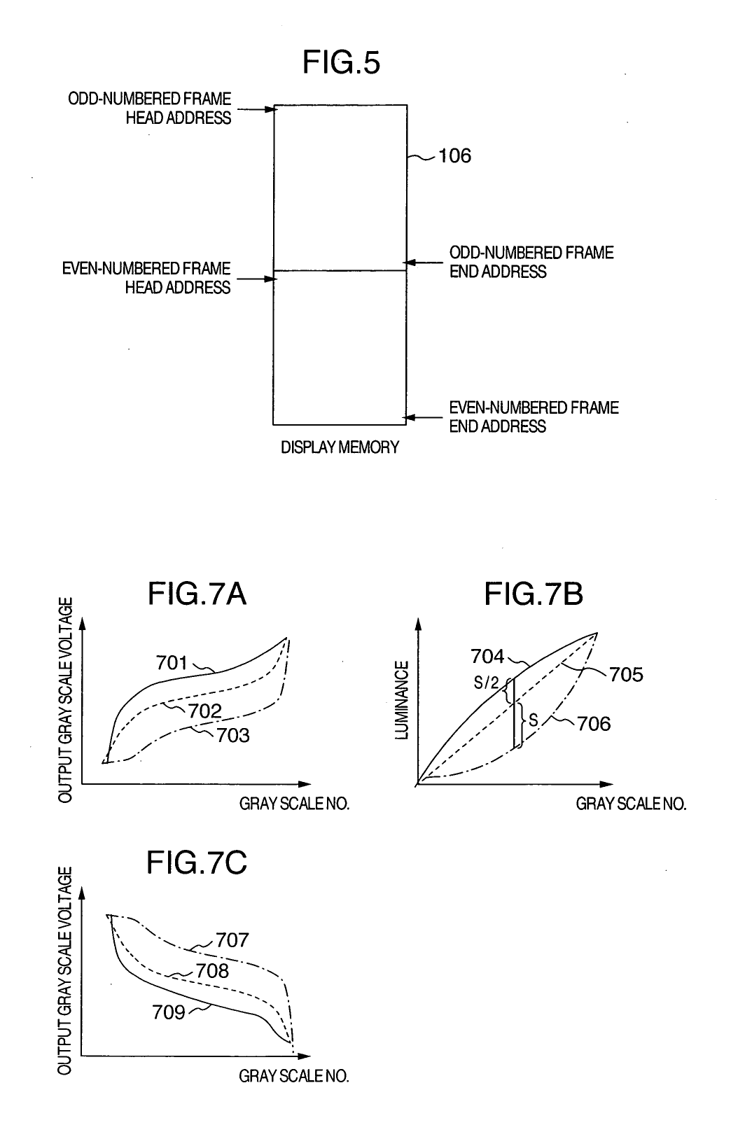

For example, as shown in FIG. 5, the memory write control circuit 104 writes display data of an odd-numbered frame to addresses ranging from an odd-numbered frame head address to an odd-numbered frame end address. Subsequently, the memory write control circuit 104 writes display data of an even-numbered frame to addresses ranging from an even-numbered frame head address to an even-numbered frame end address in synchronism with a frame signal. If display data writing of the even-numbered frame is finished, the memory write control circuit 104 returns to an odd-numbered frame head address in synchronism with a frame signal and the memory write control circuit 104 writes display data of an odd-numbered frame to addresses ranging from an odd-numbered frame head address to an odd-numbered frame end address.

The memory read control circuit 105 reads out the same display data from the display memory twice per frame period. In other words, if the memory read control circuit 105 receives a frame signal and the odd-even frame signal is “High,” the memory read control circuit 105 takes out display data corresponding to one row from an odd-numbered frame head address and outputs the display data to the column voltage output circuit 113. When the memory read control circuit 105 has read out data as far as an odd-numbered frame end address, the odd-even frame signal is “High.” Therefore, the memory read control circuit 105 returns to the odd-numbered frame head address in synchronism with a frame signal, and outputs data of the odd-numbered frame to the column voltage output circuit 113 again. Subsequently, a field signal and a frame signal are input, and the odd-even frame signal goes “Low.” As a result, the memory read control circuit 105 moves to an even-numbered head address. In addition, the memory read control circuit 105 takes out display data corresponding to one row in synchronism with each line signal. When the memory read control circuit 105 has read out data as far as an even-numbered frame end address, the odd-even frame signal is “Low.” Therefore, the memory read control circuit 105 returns to the even-numbered head address in synchronism with a field signal and outputs data of the even-numbered frame to the column voltage output circuit again. Subsequently, when the memory read control circuit 105 has read out data as far as an even-numbered frame end address, the odd-even frame signal goes “High.” Therefore, the memory read control circuit 105 moves to an even-numbered head address in synchronism with a field signal and a frame signal. The gray scale voltage generation circuit 112 generates gray scale voltages of a plurality of levels required to convert display data to gray scale voltages, and outputs gray scale voltages. For example, if display data has 8 bits, there are 256 kinds of display data and the gray scale voltage generation circuit 112 generates gray scale voltages of 256 levels. In the gray scale voltage generation circuit 112, for example, a reference voltage supplied from a power supply circuit (not illustrated) is divided by using resistors to produce gray scale voltages of 256 levels ranging from V0 to V255. Here, V0 is a gray scale voltage corresponding to data 0, and V255 is a gray scale voltage corresponding to data 255. By the way, the relation between the gray scale voltage and data may be reversed.

In the gray scale voltage conversion changeover circuit 111, changeover between values in the first gray scale voltage conversion value storage memory 109 and the second gray scale voltage conversion value storage memory 110 is conducted according to the γ preset value changeover signal generated by the timing generation circuit 107 and changed over in synchronism with a field signal. A resultant value is input to the gray scale voltage generation circuit 112.

The first gray scale voltage conversion value storage memory 109 includes a positive polarity preset value storage memory 118 for storing a first gray scale voltage conversion value for positive polarity and a negative polarity preset value storage memory 119 for storing a first gray scale voltage conversion value for negative polarity. The first gray scale voltage conversion value for positive polarity is a value based on which the gray scale voltage generation circuit 112 generates gray scale voltages of a plurality of levels for bright field of positive polarity after the γ adjustment. The first gray scale voltage conversion value for negative polarity is a value based on which the gray scale voltage generation circuit 112 generates gray scale voltages of a plurality of levels for bright field of negative polarity after the γ adjustment. The second gray scale voltage conversion value storage memory 110 includes a positive polarity preset value storage memory 120 for storing a second gray scale voltage conversion value for positive polarity and a negative polarity preset value storage memory 121 for storing a second gray scale voltage conversion value for negative polarity. The second gray scale voltage conversion value for positive polarity is a value based on which the gray scale voltage generation circuit 112 generates gray scale voltages of a plurality of levels for dark field of positive polarity after the γ adjustment. The second gray scale voltage conversion value for negative polarity is a value based on which the gray scale voltage generation circuit 112 generates gray scale voltages of a plurality of levels for dark field of negative polarity after the γ adjustment. By the way, the γ adjustment is not indispensable. The gray scale voltage conversion value may be different depending upon whether the color is R, G or B, or may be the same value. Furthermore, the first gray scale voltage conversion value is different from the second gray scale voltage conversion value regardless of whether the color is R, G or B. If the gray scale voltage generation circuit 112 divides the reference voltage by using a variable resistor, it is desirable that the gray scale voltage conversion value is its variable resistance value. If the gray scale voltage generation circuit 112 divides the reference voltage in a selection circuit, it is desirable that the gray scale voltage conversion value is a selection position in the selection circuit.

FIG. 3A shows output gray scale voltage characteristics as a function of the gray scale number in the case where the voltage at the pixel part 122 has a positive polarity. FIG. 3C shows output gray scale voltage characteristics as a function of the gray scale number in the case where the voltage at the pixel part 122 has a negative polarity. FIG. 3B shows luminance characteristics (γ characteristics) as a function of the gray scale number. The gray scale number depends upon the display data. The output gray scale voltage characteristics as a function of the gray scale number are input-output characteristics of the column drive circuit 101.

On the basis of values stored in the positive polarity preset value storage memory 118 and the negative polarity preset value storage memory 119 included in the first gray scale voltage conversion value storage memory 109 and values stored in the positive polarity preset value storage memory 120 and the negative polarity preset value storage memory 121 included in the second gray scale voltage conversion value storage memory 110, the gray scale voltage generation circuit 112 changes the voltage division ratio using resistors or the voltage division position with respect to the reference voltage. Thus, the gray scale voltage generation circuit 112 outputs gray scale voltages of four kinds in response to one display data as represented by graphs shown in FIGS. 3A and 3C. In other words, the gray scale voltage generation circuit 112 generates and outputs a gray scale voltage group in the bright field of the positive polarity represented along a characteristic curve 301, a gray scale voltage group in the bright field of the negative polarity represented along a characteristic curve 309, a gray scale voltage group in the dark field of the positive polarity represented along a characteristic curve 303, and a gray scale voltage group in the dark field of the negative polarity represented along a characteristic curve 307. FIG. 3A shows gray scale voltage characteristics obtained when the alternated signal shown in FIG. 4 has a positive polarity. FIG. 3C shows gray scale voltage characteristics obtained when the alternated signal shown in FIG. 4 has a negative polarity. The alternated signal is coupled to the counter electrode (VCOM) of each pixel. By applying the alternated signal to the liquid crystal, it is possible to swing the voltage applied to the liquid crystal to the positive polarity and the negative polarity without supplying a high voltage to a drain terminal of a transistor of each pixel 122. As a result, deterioration of the liquid crystal can be prevented. When the alternated signal has the positive polarity, therefore, changeover is conducted between the gray scale voltage group represented along the characteristic curve 301 and the gray scale voltage group represented along the characteristic curve 303 every field and a resultant gray scale voltage group is output. When the alternated signal has the negative polarity, changeover is conducted between the gray scale voltage group represented along the characteristic curve 307 and the gray scale voltage group represented along the characteristic curve 309 every field and a resultant gray scale voltage group is output. A characteristic curve 302 and a characteristic curve 308 are characteristic curves to be used when changeover is not conducted. Therefore, the characteristic curve 301 is implemented by the first gray scale voltage conversion value for positive polarity, the characteristic curve 309 is implemented by the first gray scale voltage conversion value for negative polarity, the characteristic curve 303 is implemented by the second gray scale voltage conversion value for positive polarity, and the characteristic curve 307 is implemented by the second gray scale voltage conversion value for negative polarity. By the way, besides the display mode in which the characteristic curve is changed according to whether the field is the bright field or the dark field, a display mode in which the characteristic curve remains the same regardless of whether the field is the bright field or the dark field may also be provided. In the latter-cited display mode, the gray scale voltage generation circuit 112 outputs gray scale voltages for implementing the characteristic curve 302 (in the case of the positive polarity) and the characteristic curve 308 (in the case of the negative polarity) for both the bright field and the dark field.

In the case of the positive polarity, the characteristic curve 301 for the bright field nearly coincides with the characteristic curve 302, which corresponds to the display data as it is, and the characteristic curve 303 for the dark field, at both end points as shown in FIG. 3A. In the middle part, however, the characteristic curve 301 is higher than the characteristic curves 302 and 303 on the whole. At the same gray scale number, i.e., at the same display data, therefore, the gray scale voltage for the bright field is higher than the gray scale voltage, which corresponds to the display data as it is, and the gray scale voltage for the dark field. On the contrary, the characteristic curve 303 for the dark field nearly coincides with the characteristic curve 302, which corresponds to the display data as it is, and the characteristic curve 301 for the bright field, at both end points. In the middle part, the characteristic curve 303 is lower than the characteristic curves 302 and 301 on the whole. At the same display data, therefore, the gray scale voltage for the dark field is lower than the gray scale voltage, which corresponds to the display data as it is, and the gray scale voltage for the bright field. In the case of the negative polarity, the characteristic curve 309 for the bright field nearly coincides with the characteristic curve 308, which corresponds to the display data as it is, and the characteristic curve 307 for the dark field, at both end points as shown in FIG. 3C. In the middle part, however, the characteristic curve 309 is lower than the characteristic curves 308 and 307 on the whole. At the same display data, therefore, the gray scale voltage for the bright field is lower than the gray scale voltage, which corresponds to the display data as it is, and the gray scale voltage for the dark field. On the contrary, the characteristic curve 307 for the dark field nearly coincides with the characteristic curve 308, which corresponds to the display data as it is, and the characteristic curve 309 for the bright field, at both end points. In the middle part, the characteristic curve 307 is higher than the characteristic curves 308 and 309 on the whole. At the same display data, therefore, the gray scale voltage for the dark field is higher than the gray scale voltage, which corresponds to the display data as it is, and the gray scale voltage for the bright field.

The column voltage output circuit 113 selects a gray scale voltage corresponding to display data and outputs the gray scale voltage corresponding to display data to the liquid crystal display panel 117. In association with one display data corresponding to one pixel, the column voltage output circuit 113 outputs one gray scale voltage (gray scale voltage for bright field) to the pixel part 122 during the first field period, and outputs one gray scale voltage (gray scale voltage for dark field) to the same pixel part 122 during the second field period.

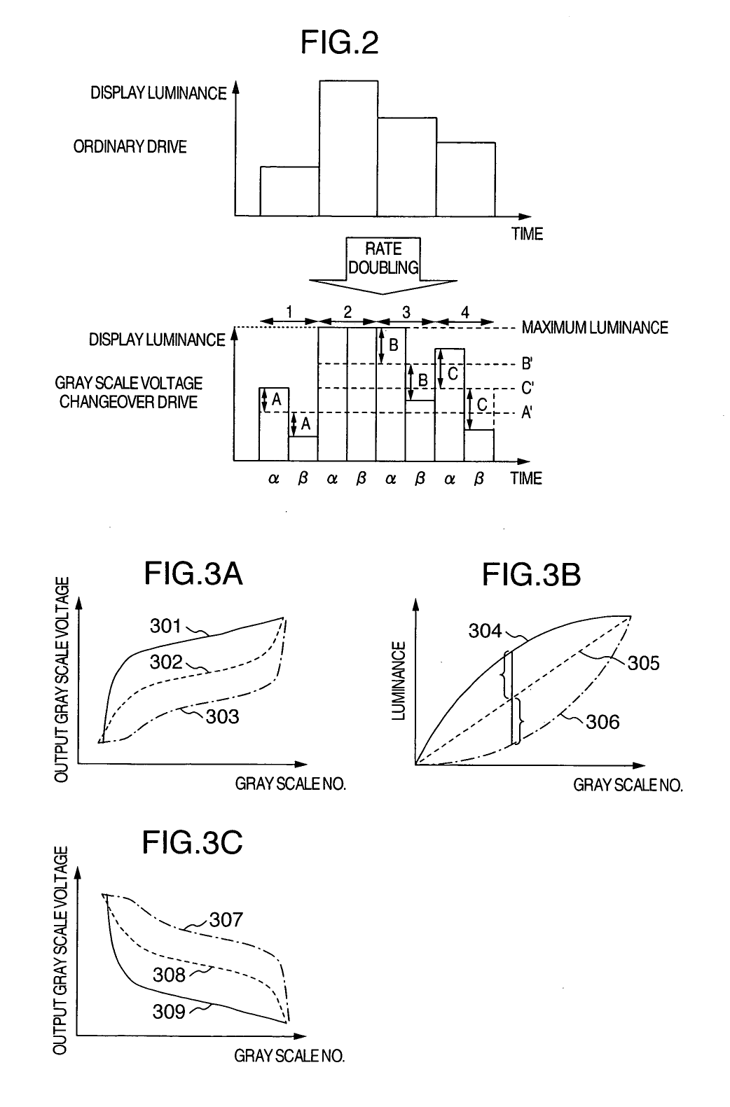

FIG. 4 shows line alternating operation. The polarity of the voltage applied to the liquid crystal is changed over between the positive polarity and the negative polarity every line of the liquid crystal. Over one frame period, the same lines have the same polarity. If the frame has changed (i.e., in the next one frame period), the same lines have opposite polarities. For example, it is supposed that a first column in a first field period in a first frame period has “H”, i.e., the negative polarity as shown in FIG. 4. Then, a first column in a second field period in the first frame period has “H”, i.e., the negative polarity. A first column in a first field period in a second frame period has “L”, i.e., the positive polarity. A first column in a second field period in the second frame period has “L”, i.e., the positive polarity. A first column in a first field period in a third frame period has “H”, i.e., the negative polarity. When gray scale voltages along the positive polarity characteristic curve 301, characteristic curve 302 and characteristic curve 303 or the negative polarity characteristic curve 309, characteristic curve 308 and characteristic curve 307 are respectively supplied to the pixel part 122, dynamic luminance at the pixel part 122 for respective gray scale levels becomes as represented by characteristic curve 304, characteristic curve 305 and characteristic curve 306, respectively. In other words, on a line where a gray scale voltage corresponding to each gray scale data has the positive polarity, changeover between the characteristic curve 301 and the characteristic curve 303 is conducted every field period. On a line having the negative polarity, changeover between the characteristic curve 309 and the characteristic curve 307 is conducted. As a result of such operation, a gray scale signal shown in an upper part of FIG. 2 is doubled in frequency. A certain pixel is displayed with a dynamic luminance higher by A over a period of a first field (a) and displayed with a dynamic luminance lower by A over a period of a second field (β). As a result, visual luminance becomes A′. Supposing that a maximum gray scale level is supplied in the next frame, the pixel is displayed at a maximum luminance over both a period of a first field (α) and a period of a second field (β). As a result, visual luminance becomes a maximum luminance. In the next frame, the pixel is displayed with a dynamic luminance higher by B over a period of a first field (α) and displayed with a dynamic luminance lower by B over a period of a second field (β). As a result, visual luminance becomes B′.

As regards the same pixel, therefore, in the first field period in the first frame period, the gray scale voltage changeover circuit 111 selects the first gray scale voltage conversion value storage memory 109, the first gray scale voltage conversion value for the negative polarity stored in the negative polarity preset value storage memory 119 is input to the gray scale voltage generation circuit 112, and gray scale voltages of a plurality of levels along the characteristic curve 309 are output from the gray scale voltage generation circuit 112 to the column voltage output circuit 113. In the second field period in the first frame period, the gray scale voltage changeover circuit 111 selects the second gray scale voltage conversion value storage memory 110, the second gray scale voltage conversion value for the negative polarity stored in the negative polarity preset value storage memory 120 is input to the gray scale voltage generation circuit 112, and gray scale voltages of a plurality of levels along the characteristic curve 307 are output from the gray scale voltage generation circuit 112 to the column voltage output circuit 113. In the first field period in the second frame period, the gray scale voltage changeover circuit 111 selects the first gray scale voltage conversion value storage memory 109, the first gray scale voltage conversion value for the positive polarity stored in the positive polarity preset value storage memory 118 is input to the gray scale voltage generation circuit 112, and gray scale voltages of a plurality of levels along the characteristic curve 301 are output from the gray scale voltage generation circuit 112 to the column voltage output circuit 113. In the second field period in the second frame period, the gray scale voltage changeover circuit 111 selects the second gray scale voltage conversion value storage memory 110, the second gray scale voltage conversion value for the positive polarity stored in the positive polarity preset value storage memory 120 is input to the gray scale voltage generation circuit 112, and gray scale voltages of a plurality of levels along the characteristic curve 303 are output from the gray scale voltage generation circuit 112 to the column voltage output circuit 113. In the line alternating operation, the voltage polarity at the pixel part 122 is inverted every line, and consequently the selection of the positive polarity preset value storage memory and the negative polarity preset value storage memory is reversed between pixels on adjacent lines (adjacent scanning lines). In dot inversion operation, the voltage polarity at the pixel part is inverted every column, and consequently the selection of the positive polarity preset value storage memory and the negative polarity preset value storage memory is reversed between pixels on adjacent columns (adjacent signal lines). By the way, the alternating operation is not indispensable to the present invention.

As a result of such operation, the visual luminance given from the external system can be displayed. The feeling of blurring can be decreased because a dark (low luminance) image is inserted between high luminance images. Furthermore, by thus generating the alternated signal while taking a frame as the unit and fixing the alternated signal between fields, the direct current component can be eliminated and deterioration of the liquid crystal can be suppressed. In the present embodiment, the bright field is displayed earlier and the dark field is displayed later. Even if the order is reversed, however, the same effect can be obtained. The present invention does not depend on the order of the bright field and the dark field.

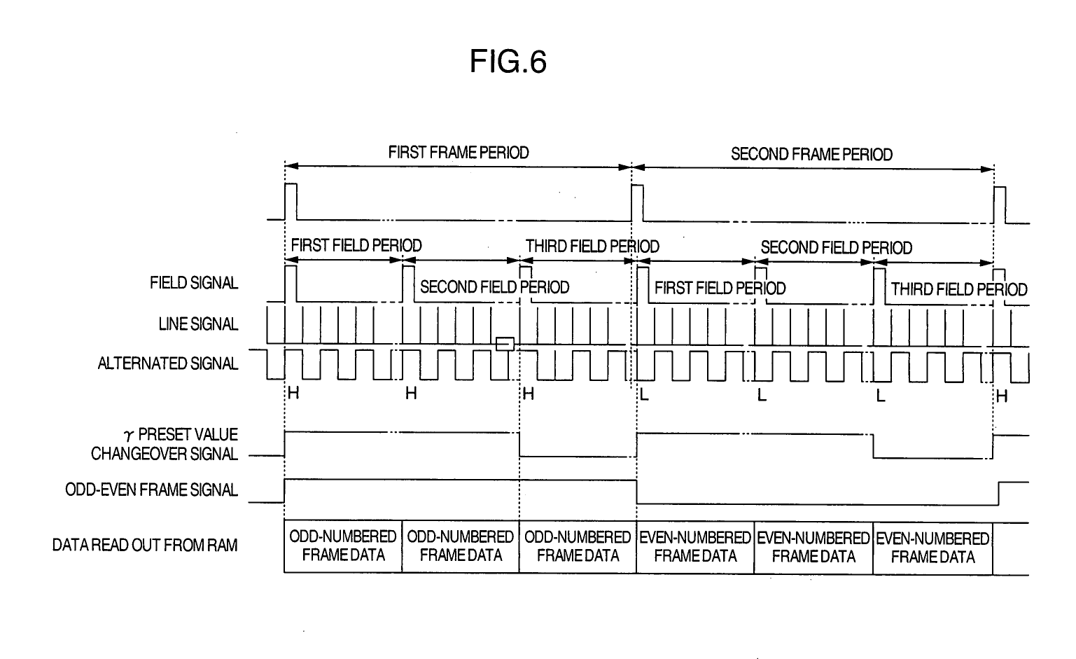

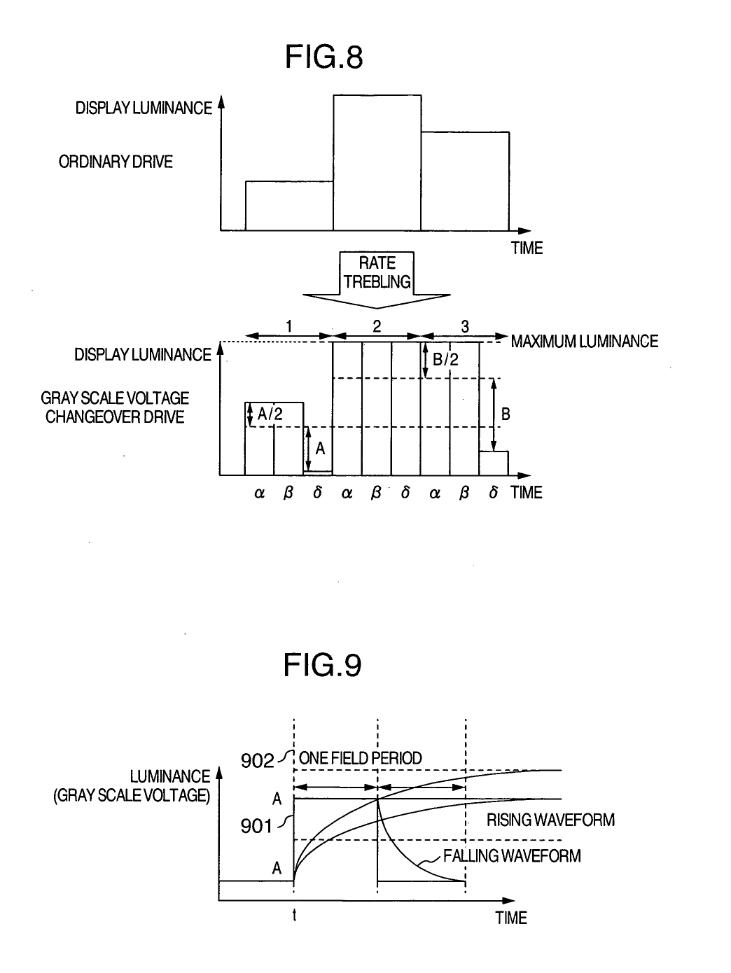

A second embodiment will now be described with reference to FIG. 1, FIG. 6, FIGS. 7A, 7B and 7C and FIG. 8. Although FIG. 1 is used in the description of the first embodiment, FIG. 1 is used in description of the second embodiment as well in common. In FIG. 1, the roles of respective blocks are the same as those in the first embodiment, and only signals produced by the timing generation circuit differ from those in the first embodiment. The present second embodiment differs from the first embodiment in that one frame period is divided to three field periods.

Operation in the present second embodiment will now be described with reference to FIG. 6.

In FIG. 6, the field signal is output at a frequency which is three time as high as that of the frame signal.

FIG. 6 also shows the line alternating operation. The polarity of the voltage applied to the liquid crystal is changed over between the positive polarity and the negative polarity every line of the liquid crystal. Over one frame period, the same lines have the same polarity. If the frame has changed, the same lines have opposite polarities. For example, it is supposed that a first column in a first field period in a first frame period has “H”, i.e., the negative polarity as shown in FIG. 4. Then, a first column in a second field period in the first frame period has “H”, i.e., the negative polarity. A first column in a third field period in the first frame period has “H”, i.e., the negative polarity. A first column in a first field period in a second frame period has “L”, i.e., the positive polarity. A first column in a second field period in the second frame period has “L”, i.e., the positive polarity. A first column in a third field period in the second frame period has “L”, i.e., the positive polarity. A first column in a first field period in a third frame period has “H”, i.e., the negative polarity.

FIGS. 7A, 7B and 7C are diagrams showing the output gray scale voltage and luminance as a function of gray scale data in the present second embodiment. FIG. 7A is a diagram showing the output gray scale voltage supplied to lines of the positive polarity. FIG. 7C is a diagram showing the output gray scale voltage supplied to lines of the negative polarity. FIG. 7B is a diagram showing the dynamic luminance as a function of the gray scale level in the case where conversion characteristics shown in FIGS. 7A and 7C are used. By supplying gray scale voltages 701, 702 and 703 on a line of the positive polarity, the dynamic luminance for respective gray scale levels of the liquid crystal becomes as represented by 704, 705 and 706. By supplying gray scale voltages 709, 708 and 707 on a line of the positive polarity, the dynamic luminance for respective gray scale levels of the liquid crystal becomes as represented by 704, 705 and 706. In the present second embodiment, a difference between the dynamic luminance 704 and 705 is set so as to become equal to half of the difference between the dynamic luminance 706 and 705.

As shown in FIG. 6, the γ preset value changeover signal generated by the timing generation circuit 107 is controlled to be “High” over first two fields and “Low” over a final one field period, in each frame. In other words, the gray scale voltage for each gray scale data is controlled in changeover to follow the curves 701 and 709 over the first two fields and follow the curves 703 and 707 over the final one field period.

Readout from the display memory is conducted in the same way as the first embodiment. When a field signal and a frame signal are input, the readout head address is updated to move to the next frame. When only a field signal is input, the address is returned to a head address of a region in which the frame read until then is stored. As a result of such operation, the gray scale signal supplied from the external system is trebled in frequency. As shown in FIG. 8, a certain pixel is displayed with a dynamic luminance higher by A/2 over a period of a first field (α) and a period of a second field (β), and displayed with a dynamic luminance lower by A over a period of a third field (δ). As a result, visual luminance becomes A′. Supposing that a maximum gray scale level is supplied in the next frame, the pixel is displayed at a maximum luminance over a period of a first field (α), a period of a second field (β) and a period of a third field (δ). As a result, visual luminance becomes a maximum luminance. In the next frame, the pixel is displayed with a dynamic luminance higher by B/2 over a period of a first field (α) and a period of a second field (β), and displayed with a dynamic luminance lower by B over a period of a third field (δ). As a result, visual luminance becomes B′.

As a result of such operation, the visual luminance given from the external system can be displayed. The feeling of blurring can be decreased because a dark (low luminance) image is inserted between high luminance images.

When a voltage step input is applied to some liquid crystal, the luminance response is slow or there is a great difference in rising and falling characteristics, in some cases. For example, as shown in FIG. 9, if rising is very slow, falling is fast and a desired luminance cannot be reached within one field period only in the rising, then a voltage 902 higher than a gray scale voltage that gives a desired luminance is supplied as a gray scale voltage on the high luminance side beforehand. Thereby, a gray scale preset value 304 higher than the ordinary gray scale voltage preset value 301 shown in FIG. 11 is supplied so as to reach the desired luminance within one field period. As a result, further favorable display characteristics can be obtained.

On the contrary, if falling is very slow, rising is fast, and a desired luminance cannot be reached within one field period only in the falling, then it becomes possible to lower the luminance to the desired luminance within one field period by previously supplying a voltage lower than a gray scale voltage that gives a desired luminance, as a gray scale voltage on the low luminance side. Further favorable display characteristics can be obtained by supplying a gray scale preset value lower than the ordinary gray scale voltage preset value 303.

In this way, further favorable display characteristics can be obtained by changing the magnitude of the gray scale voltage on the high luminance side and the gray scale voltage on the low luminance side according to the characteristics of the liquid crystal.

The present invention can be applied to TV sets, personal computers and mobile phones that display motion pictures.

It should be further understood by those skilled in the art that although the foregoing description has been made on embodiments of the invention, the invention is not limited thereto and various changes and modifications may be made without departing from the spirit of the invention and the scope of the appended claims.

1. A hold-type display device which holds gray scale display over one frame period, comprising:
a display panel having a plurality of pixels; and
a drive circuit supplied with display data which indicates luminance to be displayed at a pixel, from an external system to convert the display data to a gray scale voltage to be applied to the pixel,
wherein
the one frame period is divided to a plurality of field periods,
the drive circuit comprises a voltage generation circuit for generating a plurality of gray scale voltages and an output circuit for selecting and outputting a gray scale voltage according to the display data from among the gray scale voltages, and
the voltage generation circuit generates the gray scale voltages which are different from field to field.

2. The display device according to claim 1, wherein the gray scale voltages which are different from field to field are set so as to make an average value of luminance displayed by each of the pixels according to the gray scale voltage in each frame equal to luminance indicated by the display data supplied from the external system.

3. The display device according to claim 1, wherein a potential at a counter electrode connected to the pixels remains the same over one frame period and the potential is reversed in phase from frame to frame.

4. The display device according to claim 1, wherein
the one frame period is divided to two field periods,
a gray scale voltage supplied over a first field period in the one frame period is set in every display data to become higher than a gray scale voltage which gives a dynamic luminance to be displayed indicated by the display data, and
a gray scale voltage supplied over a second field period in the one frame period is set in every display data to become lower than the gray scale voltage which gives the dynamic luminance to be displayed indicated by the display data.

5. The display device according to claim 1, wherein
the one frame period is divided to two field periods,
a gray scale voltage supplied over a first field period in the one frame period is set in every display data to become lower than a gray scale voltage which gives a dynamic luminance to be displayed indicated by the display data, and
a gray scale voltage supplied over a second field period in the one frame period is set in every display data to become higher than the gray scale voltage which gives the dynamic luminance to be displayed indicated by the display data.

6. The display device according to claim 4, wherein a difference between a dynamic luminance obtained by using the gray scale voltage supplied over the first field period in the one frame period and the luminance to be displayed indicated by the display data is equal to a difference between a dynamic luminance obtained by using the gray scale voltage supplied over the second field period and the luminance to be displayed indicated by the display data.

7. The display device according to claim 4, wherein if time taken for luminance to change from a luminance corresponding to black display and reach a luminance corresponding to white display when each of the pixels is changed over from the black display to the white display is longer than time taken for luminance to change from a luminance corresponding to the white display and reach a luminance corresponding to the black display when each of the pixels is changed over from the white display to the black display and longer than time of each field period, then a difference between a dynamic luminance obtained by using a gray scale voltage supplied over a field period giving a low luminance and a luminance to be displayed indicated by the display data is greater than a difference between a dynamic luminance obtained by using a gray scale voltage supplied over a field period giving a high luminance and the luminance to be displayed indicated by the display data.

8. The display device according to claim 4, wherein if time taken for luminance to change from a luminance corresponding to white display and reach a luminance corresponding to black display when each of the pixels is changed over from the white display to the black display is longer than time taken for luminance to change from a luminance corresponding to the black display and reach a luminance corresponding to the white display when each of the pixels is changed over from the black display to the white display and longer than time of each field period, then a difference between a dynamic luminance obtained by using a gray scale voltage supplied over a field period giving a low luminance and a luminance to be displayed indicated by the display data is greater than a difference between a dynamic luminance obtained by using a gray scale voltage supplied over a field period giving a high luminance and the luminance to be displayed indicated by the display data.

9. A display device including a display panel having a plurality of pixels, a voltage generation circuit for generating gray scale voltages of N levels corresponding to display data of N kinds (where N is an integer of at least 2), a memory for storing display data input from outside, a control circuit for controlling writing to and reading from the memory, an output circuit for selecting a gray scale voltage corresponding to display data read from the memory, from among the gray scale voltages of the N levels generated by the voltage generation circuit and outputting the gray scale voltage to one of the pixels, and a scanning circuit for conducting scanning on a pixel to which the gray scale voltage is to be output, a luminance according to the display data input from the outside being implemented by causing the pixel to display luminance of M kinds (where M is an integer of at least 2) over one frame period,
wherein
one frame period is divided to M periods,
the display device comprises a holding circuit for holding M control data to be used by the voltage generation circuit to generate the gray scale voltages of the N levels by dividing the reference voltage,
the display device comprises a changeover circuit for changing over the M control data in association with each of the M division periods and outputting resultant control data to the voltage generation circuit,
the scanning circuit scans the pixel M times in one frame period in association with the M division periods,
the control circuit writes the display data input from the outside into the memory once in the one frame period, and reads the display data from the memory M times (where M is an integer of at least 2) in one frame period in association with the M division periods,
the voltage generation circuit generates the gray scale voltages of the N levels of M kinds according to the M control data in the one frame period in association with the M division periods, and
the output circuit outputs the gray scale voltages of the M kinds to the pixel in the one frame period in association with the M division periods.

10. The display device according to claim 9, wherein the holding circuit comprises a register for setting the M control data from the outside.

11. The display device according to claim 9, wherein
a voltage polarity at the pixel is inverted every frame period,
the holding circuit holds the M control data for positive polarity and the M control data for negative polarity, and
with respect to same pixel, the changeover circuit reads the M control data for positive polarity and the M control data for negative polarity from the holding circuit alternately every frame period and outputs resultant M control data to the voltage generation circuit.

12. The display device according to claim 11, wherein
a voltage polarity at the pixel is inverted every pixel line, and
between adjacent pixels, the changeover circuit reads the M control data for positive polarity and the M control data for negative polarity from the holding circuit alternately and outputs resultant M control data to the voltage generation circuit.

13. A display device including a display panel having a plurality of pixels, a voltage generation circuit for generating gray scale voltages of N levels corresponding to display data of N kinds (where N is an integer of at least 2), an output circuit for selecting a gray scale voltage corresponding to display data input from outside and outputting the gray scale voltage to one of the pixels, and a scanning circuit for conducting scanning on a pixel to which the gray scale voltage is to be output,
wherein
one frame period is divided to M periods (where M is an integer of at least 2), and
the voltage generation circuit generates the gray scale voltages of the N levels which differ every division period in the M division periods.

14. The display device according to claim 13, wherein the voltage generation circuit generates the gray scale voltages of the N levels which differ every division period in the M division periods regardless of RGB of the pixel.

15. The display device according to claim 13, wherein the voltage generation circuit generates the gray scale voltages of the N levels which differ every division period in the M division periods by shifting a gray scale voltage of an intermediate level included in the gray scale voltages of the N levels every division period in the M division periods.

16. The display device according to claim 15, wherein
when a voltage at the pixel has a positive polarity, the voltage generation circuit shifts the gray scale voltage of the intermediate level so as to raise it every division period in the M division periods, and
when a voltage at the pixel has a negative polarity, the voltage generation circuit shifts the gray scale voltage of the intermediate level so as to lower it every division period in the M division periods.

17. The display device according to claim 13, wherein one display data corresponding to one pixel input from outside is not changed over one frame period.

18. The display device according to claim 13, wherein a luminance according to the display data input from the outside is implemented by causing the pixel to display luminance of M kinds (where M is an integer of at least 2) in the one frame period.

19. A display device including a display panel having a plurality of pixels, a voltage generation circuit for generating gray scale voltages of N levels corresponding to display data of N kinds (where N is an integer of at least 2), an output circuit for selecting a gray scale voltage corresponding to display data input from outside and outputting the gray scale voltage to one of the pixels, and a scanning circuit for conducting scanning on a pixel to which the gray scale voltage is to be output,
wherein the gray scale voltages of the N levels generated by the voltage generation circuit are changed in one frame period, regardless of the voltage polarity at the pixel part and regardless of the RGB of the pixel.

20. A display device including a display panel having a plurality of pixels, a voltage generation circuit for generating gray scale voltages of N levels corresponding to display data of N kinds (where N is an integer of at least 2), an output circuit for selecting a gray scale voltage corresponding to display data input from outside and outputting the gray scale voltage to one of the pixels, and a scanning circuit for conducting scanning on a pixel to which the gray scale voltage is to be output,
wherein γ characteristics of the gray scale voltages of the N levels generated by the voltage generation circuit are changed in one frame period regardless of the voltage polarity at the pixel part and regardless of the RGB of the pixel.
